(19) United States
(12) Patent Application Publication
(10) Pub. No.: US 2016/0237841 A1
(43) Pub. Date: Aug. 18, 2016

(54) EXPANSION TURBINE

(71) Applicant: EXERGY S.P.A., Bologna (IT)

(72) Inventors: Claudio SPADACINI, Verbania Suna (IT); Dario RIZZI, Bususchio (IT)

(21) Appl. No.: 15/027,201

(22) PCT Filed: Sep. 11, 2014
(86) PCT No.: PCT/IB2014/064430

§ 371 Date: Apr. 4, 2016

(30) Foreign Application Priority Data
Oct. 3, 2013 (IT) MI2013A001637

(51) Int. Cl. F01D 11/14; F01D 25/24; F01K 7/16; F01D 5/04; F01D 9/04

(52) U.S. Cl. CPC F01D 11/14; F01D 5/04; F01D 9/041; F01K 7/16; F01D 25/24; F05D 2230/70; F05D 2240/60

(57) ABSTRACT

An expansion turbine including: a stator, a rotor facing the stator, a short pipe, a shaft rotatably mounted in the short pipe and removably connected to the rotor. The shaft is extractable from the short pipe from the side opposite said rotor. The turbine includes devices removably connecting the rotor to the shaft having a handling portion at a rotor front face. A front static seal, between the rotor and stator, at a radially inner position with respect to an expansion volume between the stator and rotor. The front static seal is mobile between a first position at which a passage is cleared between the stator and the rotor in fluid communication with the expansion volume, and a second position which seals the passage and isolates the expansion volume from a space for access to said handling portion. The front static seal may variable geometry and be an inflatable gasket.

### FIELD OF THE INVENTION

The present invention has as object an expansion turbine, also simply termed expander, for producing electrical and/or mechanical energy. Preferably but not exclusively, the present invention refers to the expansion turbines used in the apparatuses for producing energy by means of organic Rankine cycle (ORC). In such per se known apparatuses, working fluids are used of organic type in place of the conventional water/steam system, since an organic fluid is able to more efficiently convert heat sources at relatively low temperatures, generally between 100° C. and 300° C., but also at higher temperatures. The ORC conversion apparatuses are therefore finding wider applications in various sectors, for example in the geothermal field, in industrial energy recovery, in plans for producing energy from biomasses and from concentrated solar energy, in re-gasifiers, etc..

### BACKGROUND OF THE INVENTION

Different types of expanders/turbines are known for converting thermal energy into electrical and/or mechanical energy by means of an organic Rankine cycle (ORC). Among the most well-known types, axial expanders and radial expanders are recalled, with one or more stages in series.

In general, a turbine of known type is composed of a fixed body, termed stator, and of a movable part, termed rotor. The rotor part of the turbine is constituted by a shaft to which one or more expansion stages of the working fluid are fixed. The assembly of the rotor part and the stator part is carried out by means of a mechanical group that ensures nearly zero relative movements of the rotor and stator parts except for the rotation around the rotation axis coinciding with the shaft of the machine.

The public document WO 2012/093299, on behalf of the same Applicant, illustrates an expansion turbine that comprises: a case having an inlet and an outlet for a working fluid; a stator installed in the case; a rotor installed in the case and rotatable around a respective rotation axis; a short pipe constrained to the case; a mechanical group installed in the short pipe. The mechanical group comprises a bushing and a shaft rotatably installed in the bushing. The shaft is removably connected to the rotor and the entire mechanical group, including the shaft, can be extracted in a block from the short pipe from the side opposite the rotor. The rotor is movable along the axial direction between a first configuration, in which the mechanical group is installed in the short pipe and the rotor is spaced from the short pipe, in a manner so as to be able to rotate under the action of the working fluid, and a second configuration, in which the mechanical group is extracted from the short pipe and the rotor is abutted against the short pipe at a static seal. The turbine also comprises a tie rod which allows tightening the rotor against the shaft and rendering them integral. The shaft has an axial passage inside of which the tie rod is housed. The tie rod has a head that projects from the first end of the shaft and is connected to the rotor. The tie rod is inserted in a central hole of the rotor and the head has a spherical surface that lies against a spherical surface of the rotor directed on the opposite side with respect to the mechanical group. The tie rod has a terminal end opposite the head and projecting from the second end of the shaft. A nut screwed on the terminal end tightens the rotor against the shaft, in a manner such that the rotor and the shaft integrally rotate.

The public document WO 2012/004821 illustrates a fluid seal device for rotary machines having a rotor part including at least one disc borne by a rotary shaft that is rotatable with respect to a stator part in the presence of fluid. The rotary shaft is provided with at least one seal system defining a first setting at a first pressure. The stator part has a wall in front of the disc defining therewith a second setting that contains a fluid at a second pressure. The device comprises a movable ring placed between the wall of the stator part and the disc of the rotor part and provided with at least one front seal gasket directed towards said disc. The movable ring is axially movable between an inactive position, in which the front seal gasket is far from said disc, and an active position, in which said front seal gasket abuts against said disc. The movable ring is moved into the active position when the rotary machine is stopped in order to prevent a passage of fluid from one of said settings to the other setting.

### SUMMARY

In such context, the Applicant has observed that the turbine described and illustrated in the abovementioned document WO 2012/093299 can be improved in a manner so as to further facilitate the access to its parts and allow an even easier and more effective maintenance without having to remove the working fluid from the turbine itself.

In particular, the Applicant has perceived the need to be able to access the front face of the rotor at the rotation axis, where the means are present that constrain the shaft to the rotor itself, without having to empty the circuit within which the working fluid flows.

The Applicant has found that the above-indicated objectives can be reached by arranging, between the rotor and the stator, in a radially inner position with respect to the rotor and stator blades, a static seal which can be brought in abutment, when the turbine is stopped, both against the stator and against the rotor in a manner so as to seal the volume that is radially outside said static seal and delimited between the stator and the rotor.

More specifically, according to a first aspect, the present invention regards an expansion turbine, comprising:

a case;

a stator integrated or installed in the case and having stator blades;

a rotor mounted in the case, having rotor blades and facing the stator, wherein the rotor is rotatable around a respective rotation axis;

wherein the stator and the rotor delimit between them an expansion volume, for a working fluid, provided with said rotor and stator blades,

a short pipe integrated or installed on the case;

a shaft rotatably mounted in the short pipe and rotating around the rotation axis;

wherein the shaft is removably connected to the rotor and extractable from the short pipe from the side opposite said rotor;

characterized in that it comprises:

devices for removably connecting the rotor to the shaft having a handling portion placed at a front face of the rotor opposite the short pipe and facing at an space for access to said handling portion;

at least one front static seal interposed between the rotor and the stator and placed at a radially inner position with respect to the expansion volume; wherein the front static seal and the rotor are movable with respect to each other between a first position, in which the front static seal clears a passage in fluid communication with the expansion volume and with the space for access to said handling portion, and a second position, in which said front static seal seals said passage and sealingly isolates the expansion volume from the space for access to said handling portion.

By “handling portion” it is intended the element on which an operator must act in order to actuate (assemble/disassemble) the removable connection devices.

By “space for access to the handling portion” it is intended a space through which an operator can access the handling portion from the outside. The space for access to the handling portion is therefore in communication or it can be placed in communication with outside the case. In other words, the space for access to the handling portion is open towards or can be open towards the case exterior.

The front static seal in the second position (sealed passage) allows the operator to access the handling portion and to disassemble the shaft (by extracting it from the short pipe on the side opposite the rotor) while the working fluid remains confined in the expansion volume and cannot exit through the access space.

Preferably, such turbine is of radial centrifugal type and is part of plants for the cogeneration of energy of Rankine cycle type, which have closed circuit (such that the working fluid remains in the circuit even during maintenance) and use organic fluids with high molecular weight. The entrance of the fluid into the expansion volume occurs at a radially inner portion of the turbine, the fluid is moved by expanding towards the outside, away from the rotation axis, and exits at a radially outer portion of the turbine.

Preferably, the turbine comprises a rotor, or rotor disc, provided with a plurality of rotor blades arranged in series of concentric rings on a respective front face of the rotor. Preferably, the turbine comprises a stator provided with a plurality of stator blades arranged in series of concentric rings on a respective face of the stator. The faces with the blades are placed in front of each other in order to delimit the expansion volume for the working fluid. The series of stator blades are alternated with the series of rotor blades along a radial direction.

Preferably, such turbine is a radial centrifugal turbine with final axial stage(s).

Preferably, the turbine comprises at least one further stage of axial type arranged in radially outer position to define a radial/axial turbine. Preferably, said at least one stage of axial type is arranged at a radially peripheral edge of the rotor disc.

Preferably, said at least one stage of axial type comprises a plurality of rotor blades which are radially extended from the radially peripheral edge of the rotor disc. Preferably, the rotor blades of said at least one stage of axial type are mounted on the radially peripheral edge of the rotor disc.

The Applicant has perceived that the radial centrifugal turbine or centrifugal turbine with final axial stages is unexpectedly suitable for the use with this fluid type since:
the expansions in the ORC cycles are characterized by low enthalpy jumps and the radial centrifugal turbine is adapted for applications with low enthalpy jumps since it obtains, given the same peripheral velocity and degree of reaction, lower work levels with respect to the axial and/or radial centripetal machines ;
the expansions in the ORC cycles are characterized by low rotation velocities and by low peripheral velocities of the rotor, due to the low enthalpy jumps that characterize the abovementioned cycles, moderate temperatures or in any case non-high temperatures as in for example gas turbines, and the radial centrifugal turbine is well suited to situations with low mechanical and thermal stresses;
since the Rankine cycles in general and the ORC in particular are characterized by high volumetric expansion ratios, the radial centrifugal turbine optimizes the height of the blades of the machine, and in particular of the first stage, due to the fact that the diameter of the wheel increases in the direction of the flow; therefore, the total and non-restricted introduction is almost always possible;
given that the structural form of the radial centrifugal turbine allows obtaining multiple expansion stages on a single disc, it is possible to reduce the losses via secondary flows and expansion leaks in radial centrifugal configuration, making it unnecessary to twist the blades on the final stage of the expansion, in this manner simplifying the structure of the machine.

In a second aspect in accordance with the first aspect, the front static seal is of the type with variable geometry and is mobile with respect to the stator and to the case between the first and the second position.

By “static seal with variable geometry” it is intended an element that can assume at least two “geometric shapes/configurations”: a contracted one, in which it occupies a lower volume in order to remain spaced from a surface with which it must make a seal, and an expanded one, in which it occupies a greater volume in order to touch said surface.

In a third aspect in accordance with at least one of the preceding aspects, the turbine comprises a rear static seal defined between the short pipe and/or a rear wall and the rotor; wherein the rear static seal and the rotor are movable with respect to each other between a first position, wherein the rear static seal and the rotor are mutually spaced and a second position, wherein the rotor and said rear static seal abut against each other. The rear static seal allows isolating the housing inside the short pipe and extracting the shaft without the working fluid exiting through the space cleared by the shaft itself.

In a fourth aspect in accordance with the preceding aspect, the rear static seal is of the type with variable geometry and is mobile with respect to the stator and to the case between the first and the second position.

In a fifth aspect in accordance with one of the preceding aspects, the rotor is movable along an axial direction between a first configuration, in which it is spaced by a rear wall of the case in a manner so as to be able to rotate under the action of the working fluid, and a second configuration, in which it is sealingly abutted against the rear wall.

Preferably, the turbine comprises blocking devices adapted to block the rotor against the rear wall, and to prevent the axial translation and rotation thereof while the machine is stopped, for example for repair and/or maintenance operations.

In a sixth aspect in accordance with the preceding aspect, the turbine comprises a rear static seal defined between the short pipe and/or the rear wall and the rotor such that the rotor, in the second configuration, abuts against the short pipe and/or the rear wall at such rear static seal.

In a seventh aspect, the present invention regards a method for disassembling an expansion turbine in accordance with one or more of the preceding aspects, comprising:
moving the rotor back with respect to the short pipe until said rotor is brought against said short pipe at the rear static seal;
blocking the rotor against the short pipe;
bringing the front static seal with variable geometry in the second position;
extracting the shaft while the rotor is blocked against said short pipe.

In an eighth aspect according to one or more of the aspects from the first to the fourth, the rotor is movable along an axial direction between a first configuration, corresponding to the first position, in which it is spaced from the front static seal in a manner so as to be able to rotate under the action of the working fluid, and a second configuration corresponding to the second position, in which it is abutted against said front static seal.

Preferably, the turbine comprises blocking devices adapted to block the rotor against the front static seal and to prevent the axial translation and rotation thereof while the machine is stopped, for example for repair and/or maintenance operations.

In a ninth aspect, the present invention regards a method for disassembling an expansion turbine in accordance with one or more of the preceding aspects from the first to the fourth and/or with the eighth aspect, comprising:
advancing the rotor with respect to the short pipe until said rotor is brought against the front static seal;
blocking the rotor against the front static seal;
bringing the rear static seal with variable geometry in the second position;
extracting the shaft while the rotor is blocked.

In a tenth aspect according to one or more of the aspects from the first to the fourth, the rotor is axially fixed and the turbine comprises blocking devices adapted to prevent the rotation thereof while the machine is stopped, for example for repair and/or maintenance operations.

In an eleventh aspect, the present invention regards a method for disassembling an expansion turbine in accordance with one or more of the preceding aspects from the first to the fourth and/or with the tenth aspect, comprising:
blocking the rotation of the rotor;
bringing the front static seal with variable geometry in the second position;
bringing the rear static seal with variable geometry in the second position;
extracting the shaft while the rotor is blocked.

In a twelfth aspect in accordance with one or more of the preceding aspects, the shaft is rotatably installed, e.g. by means of bearings, in a bushing mounted in the short pipe. The bushing cannot rotate with respect to the short pipe. The bushing and the shaft form part of a mechanical group that is completely extracted from the short pipe. In other words, the shaft can be axially extracted from the short pipe together with the bushing and with possible bearings.

In a thirteenth aspect in accordance with one or more of the preceding aspects, the front static seal has a substantially circular extension coaxial with the rotation axis and is arranged all around the handling portion.

In a fourteenth aspect in accordance with one or more of the preceding aspects, the case has a front wall and a rear wall, wherein the stator is obtained in or situated at the front wall; wherein the rotor is interposed between the front wall and the rear wall.

In a fifteenth aspect in accordance with one of the preceding aspects, the removable connection devices comprise at least one screw screwed in a front seat of the shaft.

In a sixteenth aspect in accordance with the preceding aspect, the handling portion is a head of the screw (e.g. with hexagonal notch or torx).

In a seventeenth aspect in accordance with one or more of the preceding aspects, the turbine comprises a self-centering joint, preferably with toothed coupling (e.g. of Hirth type), connecting the shaft to the rotor.

In an eighteenth aspect in accordance with the preceding aspect, a portion of such joint of the shaft is obtained around a front seat of said shaft in which the removable connection devices of the rotor are engaged with the shaft itself.

In a nineteenth aspect according to one or more of the preceding aspects, the turbine comprises a substantially tubular wall coaxial with the rotation axis and delimiting the access space. Such wall allows the operator to safely access the handling portion since it prevents any possible contact with the active elements of the turbine (e.g. with the blades). Preferably, the front static seal is placed on a first end edge of the substantially tubular wall directed towards the rotor. Preferably, said passage is delimited between the first end edge of the substantially tubular wall directed towards the rotor and the rotor itself. Preferably, the substantially tubular wall forms part of the stator or in any case is integral with the stator. Preferably, the substantially tubular wall bears, in radially outer position with respect to the access passage, the first series of radially inner stator blades. In a twentieth aspect in accordance with the preceding aspect, an inlet duct for the working fluid in fluid communication with the expansion volume is obtained in a radially outer position with respect to said substantially tubular wall. The inlet duct is defined by a passage with annular section which surrounds the substantially tubular wall. Preferably, a cylindrical body, part of the case, is arranged at the substantially tubular wall and is radially spaced therefrom in a manner so as to delimit the abovementioned inlet duct.

In a twenty-first aspect according to one or more of the preceding aspects, the turbine comprises a removable cover adapted to sealingly close said access space.

In a twenty-second aspect according to the preceding aspect, the cover sealingly abuts against a second end edge of the substantially tubular wall, axially opposite the first. The seal closure serves to prevent the exit of the working fluid during the operation of the turbine, when the front static seal is in the first position, in which it clears the passage delimited between the rotor and the first end edge of the substantially tubular wall.

In a twenty-third aspect according to one or more of the preceding aspects, the shaft, apart from the possible front seat for the removable connection devices, is solid, i.e. it has no axial through duct. In this manner, the shaft is ensured a sufficient twisting resistance necessary for preventing excessive twisting deformations due to the high torques with low rotation velocities typical of the operation of the turbines in the apparatuses with Rankine cycle. Hence the present invention allows disassembling the shaft even in cases with high torque in which the solution with hollow shaft described in WO 2012/093299 is hard to achieve.

In a twenty-fourth aspect according to one or more of the preceding aspects, the front static seal is mounted on the stator and, when it is in the second position, abuts and pushes against the rotor.

In a twenty-fifth aspect according to one or more of the aspects from the first to the twenty-third, the front static seal is mounted on the rotor and, when it is in the second position, abuts and pushes against the stator.

In a twenty-sixth aspect according to one or more of the preceding aspects, the front static seal is axially movable between the first and the second position. The front static seal comes to frontally abut against the rotor or against the stator (depends on where it is mounted).

In a twenty-seventh aspect according to one or more of the aspects from the first to the twenty-fifth, the front static seal is radially movable between the first and the second position.

In a twenty-eighth aspect according to the preceding aspect, the turbine comprises an appendage with axial extension integral with the rotor, wherein the front static seal is mounted on the stator and acts radially on said appendage. The appendage is cylindrical and preferably coaxial with the rotation axis. The appendage is preferably extended cantilevered from a front face of the rotor.

In a twenty-ninth aspect according to the twenty-eighth aspect, the turbine comprises an appendage with axial extension integral with the stator, wherein the front static seal is mounted on the rotor and acts radially on said appendage. In a thirtieth aspect according to one of the aspects from the twenty-seventh to the twenty-ninth, the front static seal has variable geometry and is radially contracted in order to adhere against said appendage.

In a thirty-first aspect according to one of the aspects from the twenty-seventh to the twenty-ninth, the front static seal has variable geometry and is radially expanded in order to adhere against said appendage.

In a thirty-second aspect according to one or more of the preceding aspects, the front static seal has variable geometry and is an inflatable gasket, i.e. with advancement via pressurization. The first position of the front static seal with variable geometry is obtained by deflating the inflatable gasket. The second position of the front static seal with variable geometry is obtained by inflating the inflatable gasket.

In a thirty-third aspect according to one or more of the preceding aspects, the front static seal has variable geometry and is defined by a movable tray preferably moved by a piston, for example with hydraulic actuation.

In a thirty-fourth aspect according to one or more of the aspects from the third to the thirty-second, the rear static seal has variable geometry and is an inflatable gasket, i.e. with advancement via pressurization. The first position of the rear static seal with variable geometry is obtained by deflating the inflatable gasket. The second position of the rear static seal with variable geometry is obtained by inflating the inflatable gasket.

In a thirty-fifth aspect according to one or more of the preceding aspects, the rear static seal has variable geometry and is defined by a movable tray preferably moved by a piston, e.g. with hydraulic actuation.

In a thirty-sixth aspect according to the thirty-second and/or the thirty-fourth aspect, the turbine has at least one channel in fluid communication with the inflatable gasket and with a pressurized gas source, wherein said source can be activated on command (e.g. by means of a valve).

In a thirty-seventh aspect according to the thirty-second and/or the thirty-fourth and/or the thirty-sixth aspect, the inflatable gasket/gaskets contains/contain an inert gas, e.g. nitrogen. This solution is especially preferred if the working fluid is inflammable.

In a thirty-eighth aspect according to one or more of the aspects from among the thirty-second and/or the thirty-fourth and/or the thirty-sixth and/or the thirty-seventh, the inflatable gasket/gaskets is/are made of elastomeric material preferably reinforced with cords. Preferably, the material of the gasket is selected as a function of the type of working fluid so that it is not altered when interacting with said working fluid.

In a thirty-ninth aspect in accordance with the seventh or the ninth or the eleventh aspect, the method comprises, after having brought the front static seal and/or the rear static seal in the second position and before extracting the shaft:
removing the cover;
acting on the handling portion and removing the connection devices.

In a fortieth aspect in accordance with one or more of the preceding aspects, the present invention regards a method for disassembling an expansion turbine in accordance with one or more of the preceding aspects, comprising:
blocking the rotation of the rotor;
bringing the front static seal and the rotor to the respective second position, by moving the front static seal, if this is of the type with variable geometry, towards the rotor or the rotor towards the front static seal;
bringing the rear static seal and the rotor to the respective second position, by moving the rear static seal, if this is of the type with variable geometry, towards the rotor or the rotor towards the rear static seal;
removing the cover;
acting on the handling portion and removing the connection devices;
extracting the shaft while the rotor is blocked.

Further characteristics and advantages will be clearer from the following detailed description of a preferred but not exclusive embodiment of an expansion turbine in accordance with the present invention.

### DESCRIPTION OF THE DRAWINGS

Such description will be set forth hereinbelow with reference to the enclosed drawings, provided only as a non-limiting example, in which:

FIG. 1 illustrates, in section view, an expansion turbine according to the present invention;

FIG. 2 illustrates a portion of the turbine of FIG. 1 in a first operative configuration;

FIG. 3 illustrates the portion of FIG. 2 in a second operative configuration;

FIG. 4 illustrates a different embodiment of the portion pursuant to FIGS. 2 and 3 in the first operative configuration;

FIG. 5 illustrates the different embodiment of FIG. 4 in the second operative configuration;

FIG. 6 illustrates a different embodiment of the seal pursuant to FIGS. 2 and 3;

FIG. 7 illustrates a different portion of the turbine of FIG. 1 according to a variant of the present invention; and

FIG. 8 illustrates the portion of FIG. 7 with a different embodiment of the seal pursuant to FIG. 7.

### DETAILED DESCRIPTION

With reference to the abovementioned figures, reference number 1 indicates overall an expansion turbine in accordance with the present invention.

The illustrated expansion turbine 1 is of radial centrifugal (outflow) type used in the apparatuses for the generation of mechanical and/or electrical energy by means of organic Rankine cycle (ORC). The turbine 1 can have at least one further stage of axial type (not illustrated) arranged in radially outer position to define a radial/axial turbine.

The turbine 1 comprises a rotor 2, or rotor disc, provided with a plurality of rotor blades 2a arranged in series of concentric rings on a respective front face of the rotor 2. The turbine 1 comprises a stator 3 provided with a plurality of stator blades 3a arranged in series of concentric rings on a respective face of the stator 2. The faces with the blades 2a, 3a are placed in front of each other to delimit an expansion volume “V” for the working fluid. The series of stator blades 3a are alternated with the series of rotor blades 2a along a radial direction. In a non-illustrated embodiment variant, the turbine 1 has a series of fixed blades situated around the rotor disc and adapted to deflect the radial flow exiting peripherally into an axial flow that subsequently moves into one or more axial turbine stages.

The rotor 2 is situated in a case that comprises a front wall 4a, which defines in part the stator 3, and which also comprises a rear wall 4b placed on the opposite side of the rotor 2 with respect to the stator 3. The rear wall 4b is jointed to a short pipe 5 integral with the case.

Inside the short pipe 5, a mechanical group 6 is mounted in a reversible manner, which bears a shaft 7 that is extended along a rotation axis “X-X” and is free to rotate around said axis “X-X” together with the rotor 2, to which it is connected at a first end 7′ thereof. More in detail, the mechanical group 6 comprises a bushing 8 coaxial with the short pipe 5. The bushing 8 and/or the short pipe 5 also have grooves and/or keys, not illustrated, which prevent the relative rotation between bushing 8 and short pipe 5 around the rotation axis “X-X”.

In the bushing 8, ball bearings 9 are mounted which support the shaft 7 in a manner such that it is free to rotate around the rotation axis “X-X” within the bushing 8 itself.

In the illustrated non-limiting embodiment, the mechanical group 6 comprises two bearings 9 side-by-side and situated in an axially intermediate position of the bushing 8 and a further bearing 9 positioned at one end of the bushing 8 close to a second end 7″ of the shaft 7.

The mechanical group 5 also comprises a seal device 10 arranged between the bushing 8 and the shaft 7 at the first end 7′ of the shaft 7 and an oil seal 11 arranged between the bushing 8 and the shaft 7 at the second end 7″ of the shaft 7.

On the first end 7′ of the shaft 7, a toothing, not illustrated, is obtained which, when the turbine 1 is mounted and ready to work, is engaged with a toothing, not illustrated, obtained on the rotor 2. The two toothings define a self-centering joint of Hirth or equivalent type.

The shaft 7 has a threaded front seat 12 obtained on the first end 7′ and extended along the rotation axis “X-X”. Such seat 12 is extended for a limited section inside the shaft 7.

The rotor 2 has a central through hole 13 and a screw 14 is removably engaged in the central through hole 13 and in the threaded front seat 12 in order to integrally constrain the rotor 2 to the shaft 7. The screw 14 has a head 15 that abuts against an abutment surface 16 delimited in the central through hole 13. The screw 14, once tightened, draws the rotor 2 against the shaft 7 and maintains the toothings of the self-centering joint engaged, preventing any mutual axial and rotational movement between the rotor 2 and the shaft 7. The screw 14, the central through hole 13 and the threaded front seat 12 define devices for removably connecting rotor 2 to the shaft 7. The head 15 of the screw 14, which has for example a cavity 17 for engaging a suitable tool, defines a handling portion for said removable connection devices 14, 13, 12.

On the face of the short pipe 5 and/or of the rear wall 4b directed towards the rotor 2, an element 18 (illustrated in a schematic manner) of a rear static seal is obtained which faces a corresponding element (not illustrated) of said rear static seal present on the rotor 2. In the illustrated schematic representation, such element 18 is an annular relief and the rear static seal is defined by the abutment of such annular relief 18 against a rear surface 19 of the rotor 2, as will be further detailed below. During the normal operation of the turbine 1, such annular relief 18 remains spaced from the rear surface 19 of the rotor 2.

The case comprises a substantially tubular wall 20 which is placed in front of the rotor 2 in a radially inner central position with respect to the expansion volume “V”. The substantially tubular wall 20 is coaxial with the shaft 2 and internally delimits an access space 21 facing the head 15 of the screw 14. Said access space 21 is defined by the through duct defined by the substantially tubular wall 20. The substantially tubular wall 20 is integral with the remaining parts of the case and with the stator 3. A first axial end of the substantially tubular wall 20 has a first end edge provided with a first surface 22 directed towards the rotor 2 and spaced therefrom by an interspace. A second axial end of the substantially tubular wall 20, opposite the first axial end, has a second end edge provided with a second surface 23. The first axial end also bears a kind of flange 24.

A cylindrical body 25 is arranged around the substantially tubular wall 20, is coaxial with the shaft 2 and is integral with the walls 4a, 4b of the case and with the stator 3. Between the cylindrical body 25 and the substantially tubular wall 20, an inlet duct 26 is delimited for the working fluid in the expansion volume “V”. The inlet duct 26 has an annular shape, in a section orthogonal to the rotation axis “X-X”. A first axial end of the inlet duct 26 close to the rotor 2 is in fluid communication with the expansion volume “V”. In particular, said first axial end of the inlet duct 26 is delimited by the cylindrical body 25 and by the flange 24. The flange 24 has a curved surface 27 which determines the passage of the working fluid from an axial direction (into the inlet duct) to a radial direction (into the expansion volume “V”). The flange 24 also bears the first series, radially more internal, of stator blades 3a and therefore forms part of said stator 3.

A removable cover 28 sealingly closes the access space 21 by abutting against the second surface 23 of the substantially tubular wall 20. Such cover 28 is fixed, for example with non-illustrated removable screws, to the substantially tubular wall 20. An annular flange 28a instead stably closes a second axial end of the inlet duct 26, opposite the first. The cylindrical body 25 also has a radial opening 29 for the introduction of the working fluid coming from the circuit placed upstream of the turbine 1.

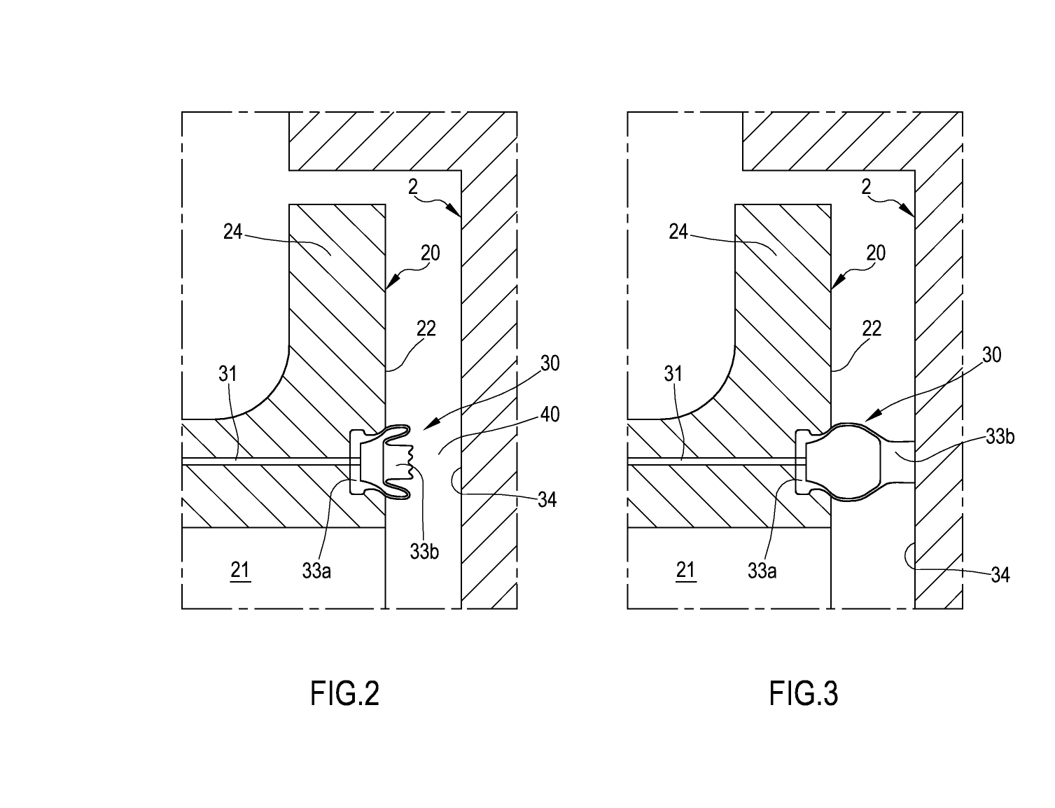

A front static seal with variable geometry 30 is positioned on the first surface 22 of the substantially tubular wall 20 and is directed towards the rotor 2. In the illustrated embodiment, the front static seal with variable geometry 30 is an inflatable gasket attached to the first surface 22 and has an annular shape (not visible in the figures) which is extended all around the access space 21 that is opened towards the rotor 2 and towards the head 15 of the screw 13. The inflatable gasket 30 is connected by means of one or more channels 31 obtained in the substantially tubular wall 20 to a pressurized air/gas source 32 (e.g. nitrogen). The inflatable gasket 30 can be inflated and deflated on command. The inflatable gasket 30 is made of elastomeric material reinforced with cords and has a base portion 33a stably housed in a seat made in the first surface 22 and an active portion 33b intended, when inflated, to be expanded, to come into contact and press against a surface 34 of the rotor 2 in a manner so as to ensure the seal for preventing the passage of the working fluid (FIGS. 2 and 3).

In a non-illustrated embodiment variant, the inflatable gasket 30 is mounted on the rotor 2 and the active portion 33b is intended, when inflated, to be expanded, to come into contact and to press against the first surface 22.

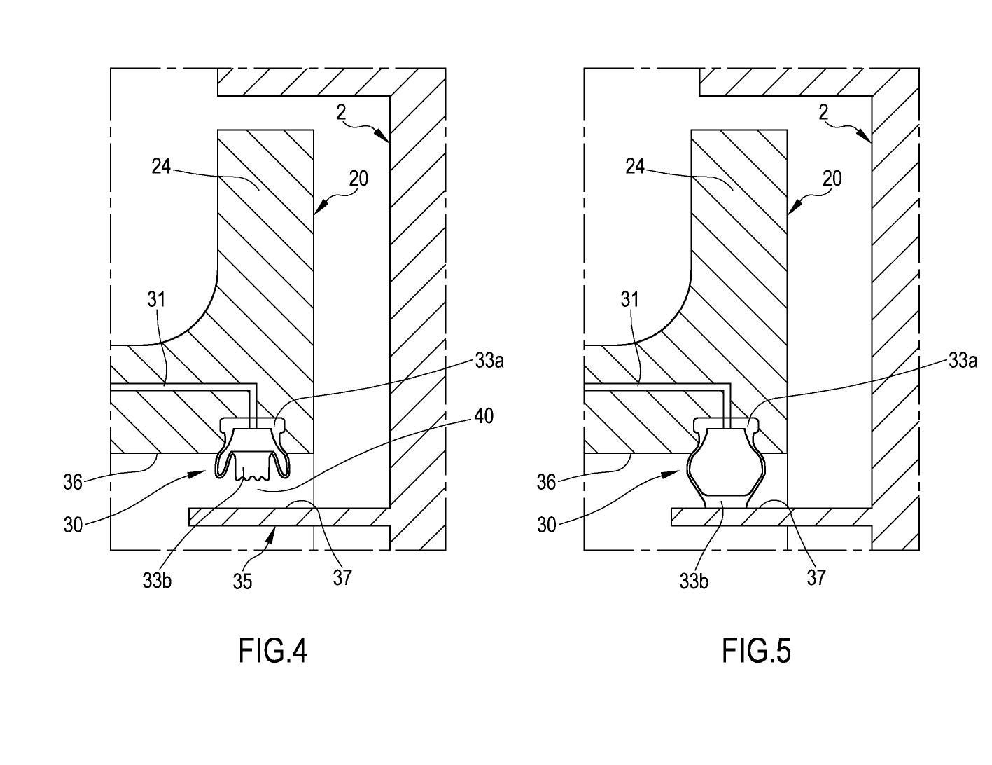

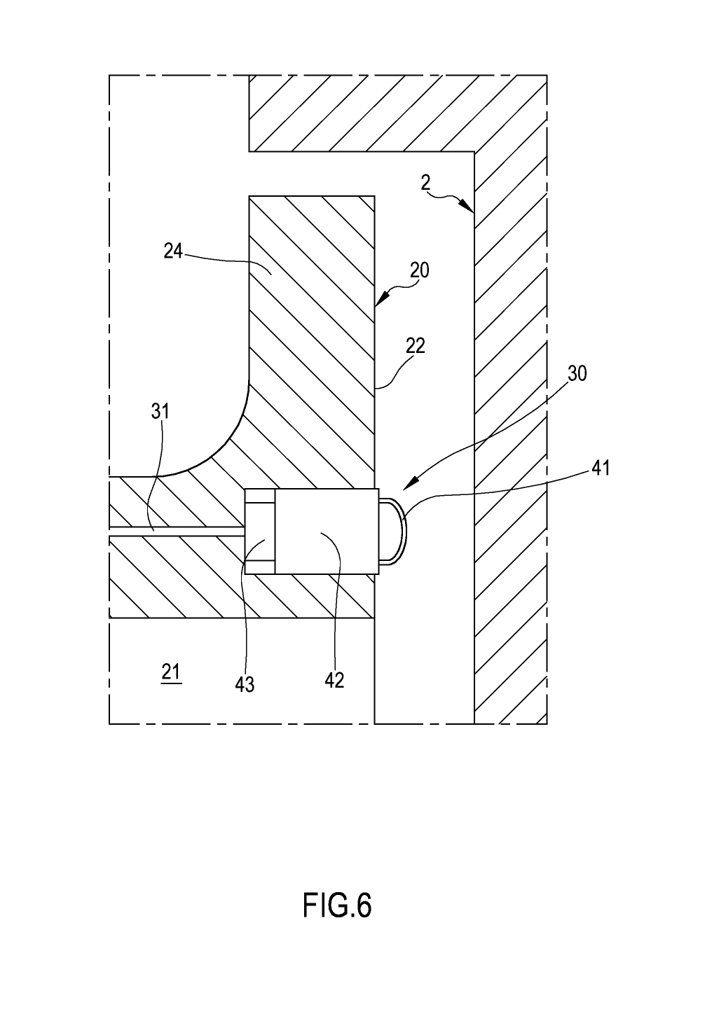

In a different embodiment, schematically illustrated in FIGS. 4 and 5, the inflatable gasket 30 acts radially. The rotor 2 comprises an appendage 35 defined by a cylindrical body coaxial with the rotation axis and with the shaft 7 that is extended cantilevered from the rotor 2 itself and enters partially inside the access space 21. The base portion 33a of the inflatable gasket 30 is housed in a seat made in a radially inner surface 36 of the substantially tubular wall 20 and the active portion 33b faces towards a radially outer surface 37 of the appendage 35. The active portion 33b is intended, when inflated, to be expanded, to come into contact and to press against the radially outer surface 37 of the appendage 35 in a manner so as to ensure the seal for preventing the passage of the working fluid. In an embodiment variant, not illustrated, of the different embodiment the inflatable gasket 30 is mounted on the appendage 35 and the active portion 33b is intended, when inflated, to be expanded, to come into contact and to press against the radially inner surface 36 of the substantially tubular wall 20.

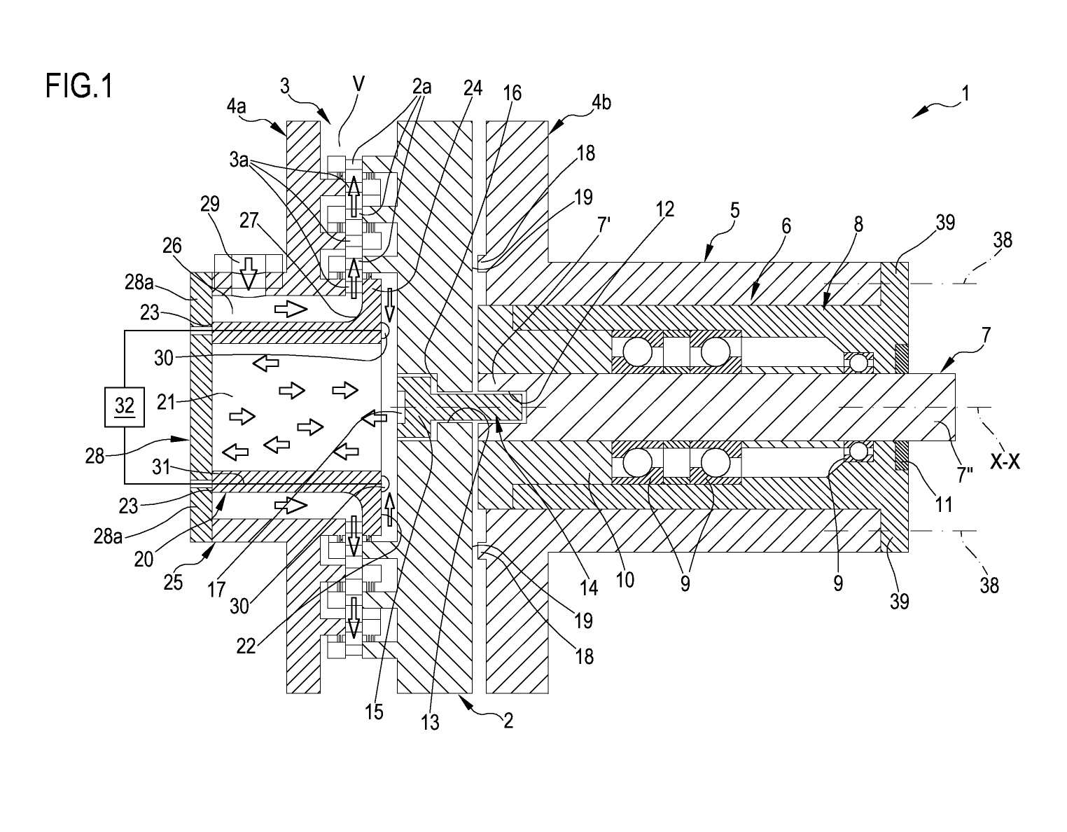

When the turbine 1 is correctly mounted for working (FIG. 1), the bushing 8 is inserted and locked in the short pipe 5 by means of screws 38 (of which only the axes are illustrated) inserted in a flange 39 of the bushing 8 and in the short pipe 5 itself. The shaft 7 is integral with the rotor 2 (by means of the screw 14 and of the toothed joint) and the rotor 2 is spaced both from the wall 4 (and from the annular element 18) and from the inflatable gasket 30. The shaft 7 and the rotor 2 are free to rotate but are axially fixed. The inflatable gasket 30 is deflated and clears a passage 40 (front static seal with variable geometry 30 in the first position, FIGS. 2 and 4) between the first axial end of the substantially tubular wall 20 and the rotor 2 through which the working fluid can pass. The removable cover 28 sealingly closes access space 21.

During operation, the working fluid flows through the radial opening 29 into the inlet duct 26, flows axially towards the expansion volume “V” and is expanded herein, making the turbine 1 rotate. While the turbine 1 rotates, the working fluid also fills the access space 21 so that it is free to flow through the passage 40.

In a different embodiment of the front static seal 30, in place of an inflatable gasket, a movable tray gasket is employed which has a fixed gasket 41 positioned on a tray 42; the movable tray gasket is moved by one or more hydraulic pistons 43 supplied by means of one or more channels 31.

For disassembling the mechanical group 6 and the shaft 7, after having stopped the rotor 2, the screws 38 are first extracted, in a manner so as to remove the axial block between the bushing 8 and the short pipe 5, and the entire mechanical group 6 (shaft 2, seal device 10, bearings 9, bushing 8, oil seal 11) and the rotor 2 integral therewith (together with the screw 14 and the toothed joint) are moved axially back (to the right in FIG. 1) until the rear surface 19 of the rotor 2 is brought against the annular relief 18 and achieves the rear static seal. This translation moves the surface 34 of the rotor 2 away from the inflatable gasket 30 by slightly increasing the passage 40 (visible in the comparison between FIGS. 2 and 3). At this point, the rotor 2 is blocked against the rear wall 4b with suitable devices, not shown.

Subsequently, the gas is inserted through the channels 31 into the inflatable gasket 30 in a manner so to inflate it until the active portion 33b is brought against the surface 34 of the rotor 2, coming to sealingly close the passage 40 (front static seal with variable geometry 30 in the second position, FIG. 3). While the gasket 30 is inflated, the active portion 33b translates in axial sense by following the entire distance that separated it from the rotor 2, before then being abutted and pushing against the rotor 2 itself. In such second position, the inflatable gasket 30 seals and isolates the access space 21 from the expansion volume “V” and from the rest of the circuit.

At this point, possibly after having extracted (with suitable non-illustrated devices) from the access space 21 the limited quantity of working fluid present therein, the removable cover 28 is disassembled, separating it from the second surface 23 of the substantially tubular wall 20.

The operator can then freely access the head 15 of the screw 14, unscrew it and extract it, releasing the shaft 7 from the rotor 2.

The entire mechanical group 6 (constituted by the bushing 8, by the shaft 7, by the bearings 9, by the seal 10 and by the oil seal 11) is extracted by removing it from the short pipe 5 and moving it away from the rotor 2 (from left to right in FIG. 1) while the rotor 2 itself remains in its position. The rear static seal 18, 19 prevents the working fluid from flowing inside the short pipe 5, into the space cleared by the mechanical group 6. The inflated front static seal with variable geometry 30 prevents the working fluid from flowing inside the handling space 21 lacking cover 28.

After having executed the necessary operations on the mechanical group 6 (for example: testing, maintenance, repair), the latter is reinserted in the short pipe 5 (from right to left in FIG. 1) until the first end 7′ of the shaft 7 is brought against the rotor 2 (at the self-centering joint) while the rotor 2 is still blocked against the rear wall 4b. The screw 14 is reinserted through the rotor 2 and into the shaft 7 and tightened. The access space 21 is re-closed by means of the removable cover 28.

At this point, the inflatable gasket 30 is deflated, bringing it back into the first position and freeing the passage 40.

The rotor 2 is released from the rear wall 4b and the entire mechanical group 6 (shaft 2, seal device 10, bearings 9, bushing 8, oil seal 11) and the rotor 2 integral thereto (together with the screw 14 and the toothed joint) are axially advanced (to the left in FIG. 1) until the flange 39 of the bushing 8 is brought against the short pipe 5. Finally, the screws 38 are inserted and tightened in their housings in the flange 39 and in the bushing 8.

In the different embodiment illustrated in FIGS. 4 and 5, the disassembly/reassembly operations are the same as those described above except for the fact that while the gasket 30 is inflated, the active portion 33b is moved in a radial sense, following the entire distance that separated it from the radially outer surface 37 of the appendage 35, before then being abutted and pushing against said radially outer surface 37.

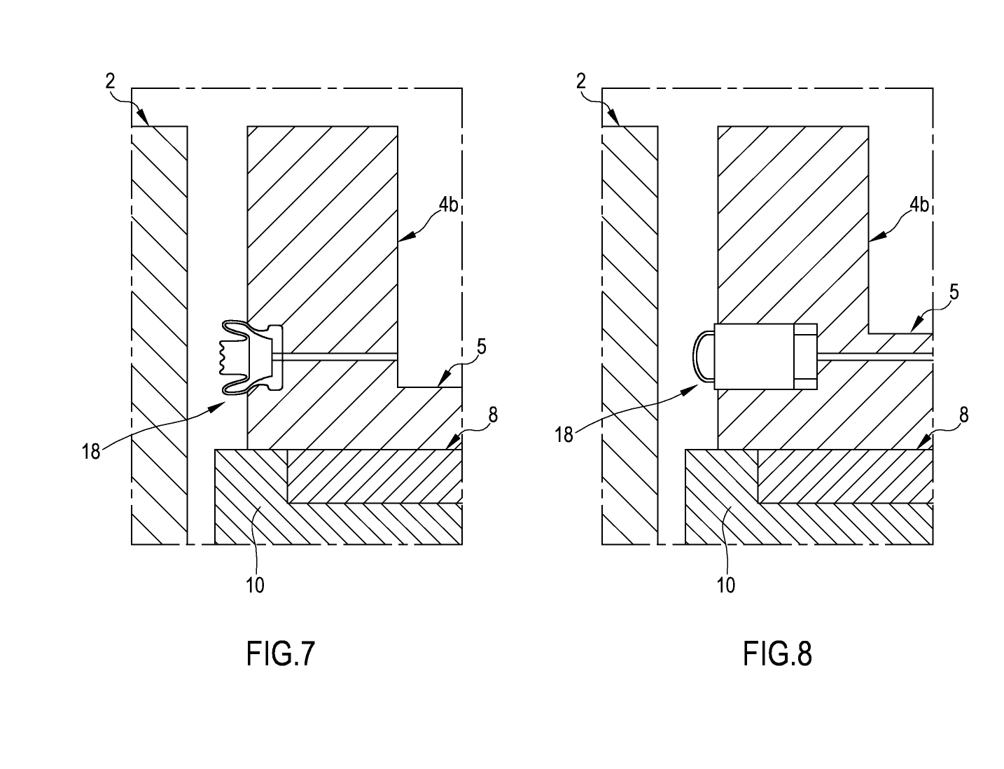

In a different embodiment, not illustrated in its entirety, the front static seal 30 is fixed while the rear static seal 18 has variable geometry. In FIGS. 7 and 8, respective embodiment variants of the rear static seal 18 with variable geometry are represented: one is an inflatable gasket and the other is of tray type. For disassembling the mechanical group 6 and the shaft 7, the rotor 2 is advanced (rather than moved back) in order to sealingly abut against the front static seal 30 and the rear static seal 18 is moved (inflated or moved) in order to be abutted against the rotor 2.

In a further different embodiment, not illustrated in its entirety, both the front static seal 30 and the rear static seal 18 have variable geometry (like the inflatable gasket of FIG. 7 or like the tray gasket of FIG. 8). For disassembling the mechanical group 6 and the shaft 7, the rotor 2 remains axially fixed. The two static seals 30, 18 are moved in order to sealingly abut against the two opposite sides of the rotor 2.

1. An expansion turbine comprising:
a case;
a stator integrated or installed in the case and having stator blades;
a rotor mounted in the case, having rotor blades and facing the stator, wherein the rotor is rotatable around a respective rotation axis (X-X);
wherein the stator and the rotor delimit between them an expansion volume (V) for a working fluid, provided with said rotor and stator blades;
a short pipe integrated or installed on the case;
a shaft rotatably mounted in the short pipe and rotating around the rotation axis (X-X);
wherein the shaft is removably connected to the rotor and said shaft is extractable from the short pipe from the side opposite said rotor;
a device configured to removably connect the rotor to the shaft having a handling portion placed at a front face of the rotor opposite the short pipe and facing at a space configured to allow access to said handling portion;
at least one front static seal interposed between the rotor and the stator and placed at a radially inner position with respect to the expansion volume (V);
wherein the front static seal and the rotor are movable with respect to each other between a first position at which the front static seal clears a passage in fluid communication with the expansion volume (V) and with the space for access to said handling portion, and a second position at which wherein said front static seal seals said passage and sealingly isolates the expansion volume (V) from the space for access to said handling portion.

2. The turbine according to claim 1, further comprising a rear static seal between the short pipe and/or a rear wall and the rotor; wherein the rear static seal and the rotor are movable with respect to each other between a first position, wherein the rear static seal and the rotor are mutually spaced, and a second position, wherein the rotor and said rear static seal abut.

3. The turbine according to claim 1, wherein the front static seal and/or the rear static seal is/are of a variable geometry and is/are movable with respect to the stator and to the case between the respective first and second positions.

4. The turbine according to claim 3, wherein the static seal with variable geometry is axially or radially movable.

5. The turbine according to claim 3, wherein the static seal with variable geometry is an inflatable gasket.

6. The turbine according to claim 5, having at least one channel in fluid communication with the inflatable gasket and with a pressurized gas source which configured to be activated on command

7. The turbine according to claim 5, wherein the inflatable gasket contains an inert gas.

8. The turbine according to claim 1, comprising a tubular wall delimiting the access space; wherein an inlet duct for the working fluid is obtained in a radially outer position with respect to said tubular wall.

9. The turbine according to claim 1, comprising a removable cover adapted to sealingly close said access space.

10. The turbine according to claim 2, wherein the rotor is movable along an axial direction between a first configuration, in which the rotor is spaced by a rear wall of the case to rotate under the action of the working fluid, and a second configuration, in which the rotor is sealingly abutted against the rear wall, wherein the rotor, in the second configuration, abuts against the short pipe and/or the rear wall at said rear static seal.

11. The turbine according to claim 1, wherein the removable connection devices comprise at least one screw screwed in a front seat of the shaft, wherein the handling portion is a head of the screw.

12. The turbine according to claim 8, wherein the front static seal is placed on a first end edge of the substantially tubular wall directed towards the rotor.

13. The turbine according to claim 8, wherein said passage is delimited between the first end edge of the substantially tubular wall directed towards the rotor and the rotor.

14. The turbine according to claim 8, wherein an inlet duct for the working fluid in fluid communication with the expansion volume (V) is obtained in a radially outer position with respect to said tubular wall, wherein the inlet duct is defined by a passage with annular section which surrounds the tubular wall.

15. The turbine according to claim 9, wherein the cover sealingly abuts against a second end edge of the tubular wall, axially opposite a first end edge of the tubular wall directed towards the rotor.

16. The turbine according to claim 1, wherein the turbine comprises an appendage with axial extension integral with the rotor or with the stator, wherein the front static seal is mounted on the stator or on the rotor and acts radially on said appendage.

17. A method for disassembling an expansion turbine wherein the expansion turbine includes a case; a stator with stator blades within the case; a rotor in the case, having rotor blades and facing the stator, wherein the rotor is rotatable around a rotation axis (X-X); wherein the stator and the rotor define an expansion volume (V) for a working fluid; a short pipe integrated or installed on the case;
a shaft rotatably mounted in the short pipe and rotating around the rotation axis (X-X); wherein the shaft is removably connected to the rotor and said shaft is extractable from the short pipe from the side opposite said rotor; a device configured to removably connect the rotor to the shaft having a handling portion placed at a front face of the rotor opposite the short pipe and facing at a space configured to allow access to said handling portion; at least one front static seal interposed between the rotor and the stator and placed at a radially inner position with respect to the expansion volume (V); wherein the front static seal and the rotor are movable with respect to each other between a first position at which the front static seal clears a passage in fluid communication with the expansion volume (V) and with the space for access to said handling portion, and a second position at which said front static seal seals said passage and sealingly isolates the expansion volume (V) from the space for access to said handling portion, wherein the method comprises:
blocking rotation of the rotor;
bringing the front static seal and the rotor to the respective second position;
bringing the rear static seal and the rotor to the respective second position;
removing the cover;
acting on the handling portion and removing the connection devices;
extracting the shaft while the rotor is blocked.

18. The method according to claim 17, further comprising:
moving the rotor back with respect to the short pipe until said rotor is brought against said short pipe at the rear static seal;
blocking the rotor against the short pipe;
bringing the front static seal with variable geometry in the second position;
extracting the shaft while the rotor is blocked against said short pipe.

19. The method according to claim 17, further comprising:
advancing the rotor with respect to the short pipe until said rotor is brought against the front static seal;
blocking the rotor against the front static seal;
bringing the rear static seal with variable geometry to the second position;
extracting the shaft while the rotor is blocked.

20. The method according to claim 17, comprising:
blocking the rotation of the rotor;
bringing the front static seal with variable geometry to the second position;
bringing the rear static seal with variable geometry to the second position;
extracting the shaft while the rotor is blocked.

21. The method according to claim 17, further comprising, after having brought the front static seal and/or the rear static seal to the second position and before extracting the shaft:
removing the cover;
acting on the handling portion and removing the connection devices.
